(19) United States
(12) Patent Application Publication
(10) Pub. No.: US 2006/0174543 A1
(43) Pub. Date: Aug. 10, 2006

(54) Engaging piece for window regulator

(76) Inventors: Hendrik Rothe, Mombris-Daxberg (DE); Christoph Buchta, Neuried (DE); Harald Wellershaus, Munchen (DE)

Correspondence Address: CLARK HILL, P.C., 500 WOODWARD AVENUE, SUITE 3500, DETROIT, MI, 48226, US

(21) Appl. No.: 11/371,858

(22) Filed: Mar. 9, 2006

(30) Foreign Application Priority Data
Jan. 27, 2005 (DE) DE 102004004000.4

(51) Int. Cl. E05F 11/48

(52) U.S. Cl. 49/352

(57) ABSTRACT

To simplify subsequent adjustment of a window pane in the drivers (4) of a window lift mechanism, it is suggested to design this mechanism such that clamping is possible without accessing the screw that is inserted during assembly. This is achieved on a driver (4, 5) with a flat receiving fork (7) and a screw (14) for pulling the sides (9, 10) of the receiving fork (7) together in that one side (9) in the vicinity of the axis of the screw (14) comprises a number of openings (19), through which a pressure piece (13) that can be operated from the outside of the side (9) protrudes into the gap (8) between the sides (9, 10). The pressure piece (13) can preferably be displaced in a substantially parallel direction to the axis of the screw (14). Furthermore, it may be provided to design the operation of the pressure piece (13) in a self-locking manner, for example, in that the pressure piece (13) can be operated by means of contact with a threaded nut (11).

### BACKGROUND OF THE INVENTION

1. Field of the Invention

The present invention relates to a driver for connecting a window pane to a window lift mechanism. The invention furthermore relates to a window lift mechanism comprising such a driver.

2. Description of the Related Art

The prior art discloses side windows in vehicles, which may be opened by pulling the window pane downward into a pocket-like recess. Such windows typically comprise a window lift mechanism both for guiding and for operating the window pane. In conventional window lift mechanisms, the window pane is retained by drivers, which are disposed displaceably on guide rails extending in the direction of movement of the window pane. This is disclosed, for example, in DE 43 21 616 A1.

The previously known window lift mechanisms, as well as the drivers disclosed therein, however, are associated with disadvantages. In particular, it is not possible to detach the mount of the window pane in the drivers after all parts have been completely installed in a vehicle door, for example, in order to perform readjustments.

It is the object of the present invention to create a window lift mechanism as well as drivers for a window lift mechanism, which allow simple realignment of the window pane even following installation in a vehicle door.

### SUMMARY OF THE INVENTION

According to one aspect of the invention, there is provided a driver for a window lift mechanism in a vehicle. The driver includes a flat receiving fork and a screw for tightening the sides of the receiving fork. One side in the vicinity of the axis of the screw comprises a number of openings, through which a pressure piece that can be operated from the outside of the side extends into the gap between the sides.

### BRIEF DESCRIPTION OF THE DRAWINGS

A preferred embodiment of the present invention will be explained in more detail hereinafter with reference to the embodiments that are schematically illustrated in the figures, wherein:

FIG. 1 is a perspective view of a cross-cable window lift mechanism;

FIG. 2 is an exploded, oblique view of an inventive driver;

FIG. 3 is another exploded, oblique view of the driver from FIG. 1;

FIG. 4 is another exploded, oblique view of the driver from FIG. 1;

FIG. 5 is yet another exploded view of the driver from FIG. 1;

FIG. 6 is a top view of the driver from FIG. 1;

FIG. 7 is a side view of the driver from FIG. 6;

FIG. 8 is a bottom view of the driver from FIG. 1; and

FIG. 9 is a sectional view through the driver from FIG. 1 in the plane A-A from FIG. 6.

### DETAILED DESCRIPTION OF THE PREFERRED EMBODIMENT

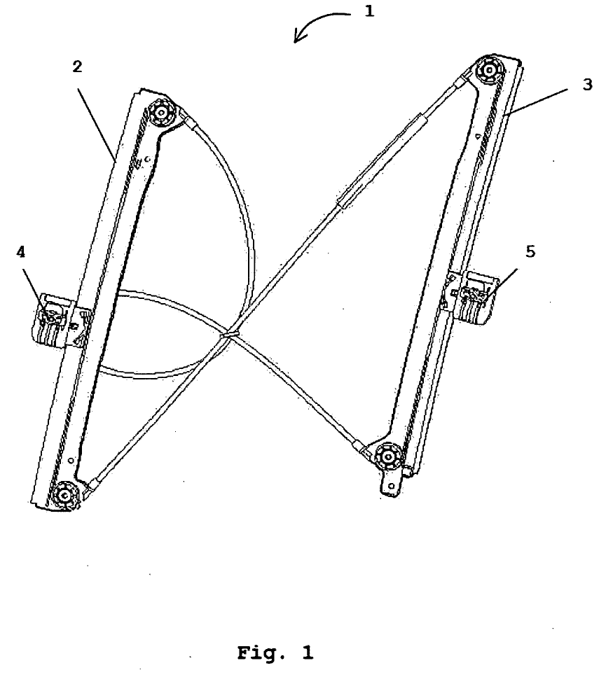

According to FIG. 1, a window lift mechanism, and particularly, a cross-cable window lift mechanism 1 comprises two guide rails 2, 3 on each of which a driver 4, 5 is disposed displaceably. The drivers 4, 5 furthermore can be driven along the guide rails 2, 3 via a central drive by connecting them to a common load cable. The drivers 4, 5 serve the connection of a window pane to the window lift mechanism 1. The connection is established in that two lower sections of the window pane are inserted in a slot-shaped orifice of the drivers 4, 5 and are mounted there non-positively. If necessary, it is also conceivable to provide additionally a positive mount with play.

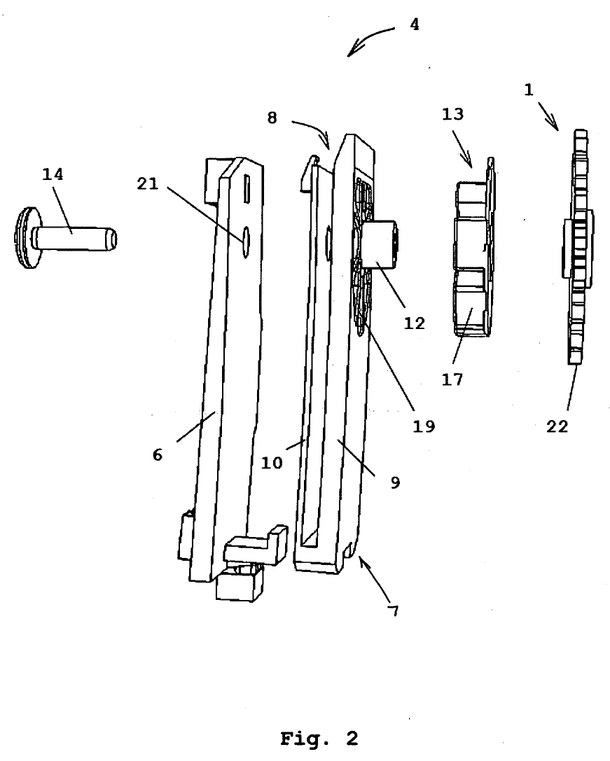

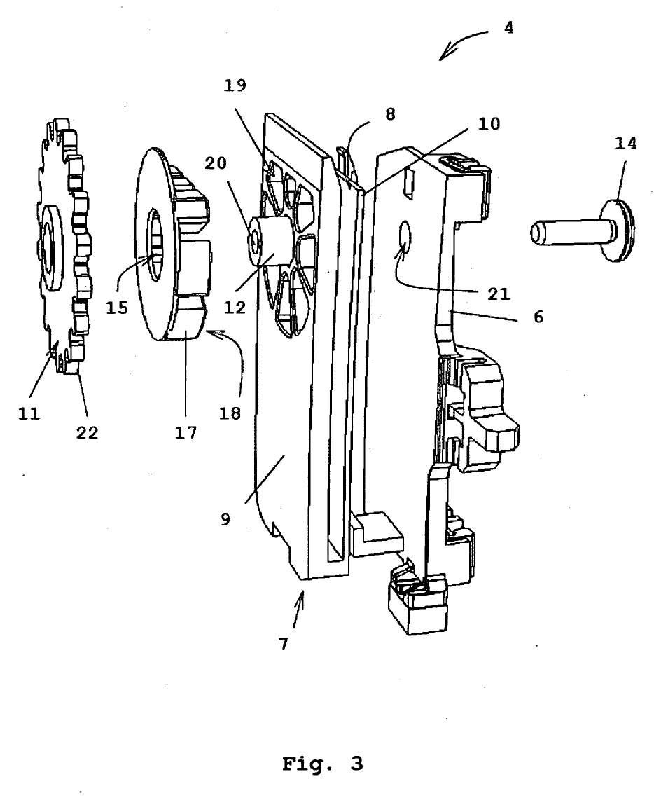

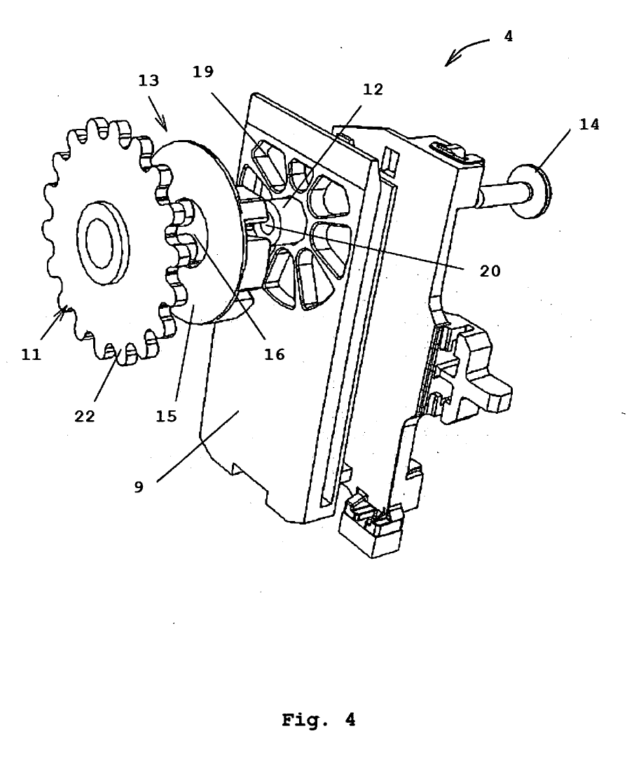

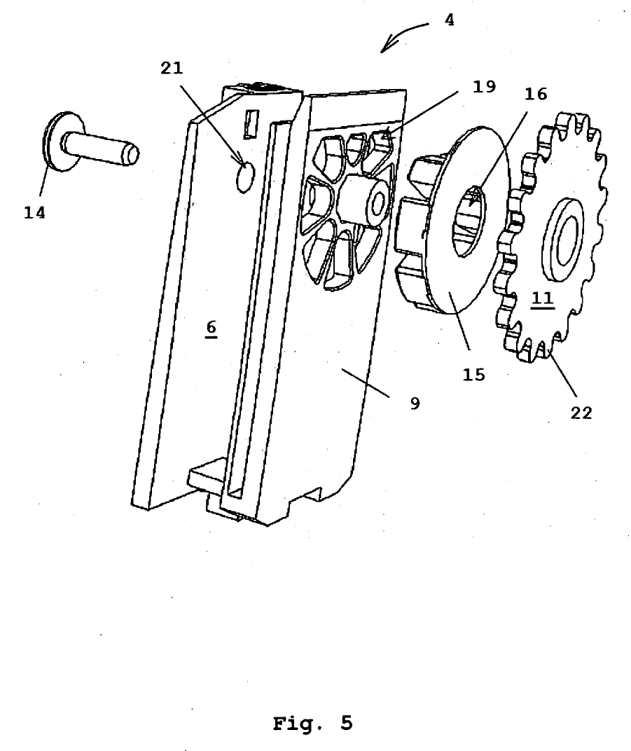

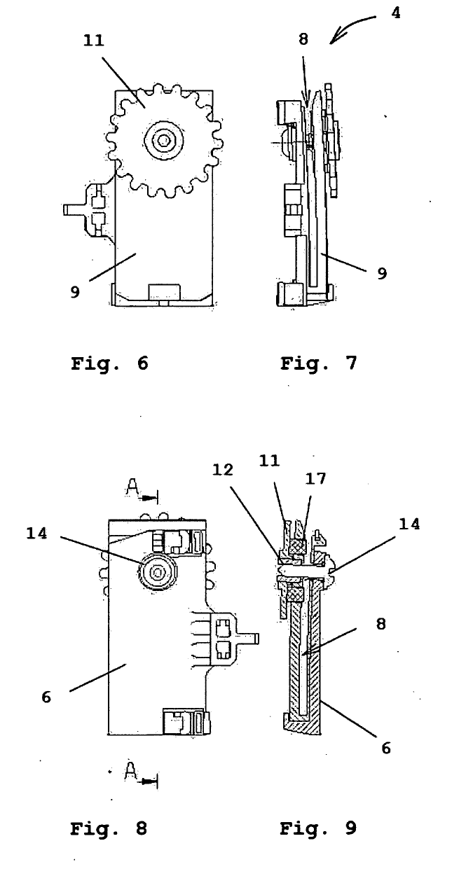

According to FIGS. 2-4, a driver 4 comprises a base plate 6 with the known means for connecting it to the guide rail 2. A flat receiving fork 7 is connected to the base plate 6. This connection is preferably accomplished with a catch, as illustrated. Alternatively, the receiving fork 7 can also be configured as one piece together with the base body 6. The gap 8 between the sides 9, 10 of the receiving fork 7 is dimensioned such that it accommodates the lower section of a window pane. In particular, the width of the gap 8 is dimensioned such that a section of a window pane can be received therein with slight play. In order to fix the window pane section inserted in the gap 8, a threaded nut 11, a threaded sleeve 12, a pressure piece 13 and a screw 14 are provided. The pressure piece 11 comprises a section having the shape of a flat circular disk 15 on its back. From an end face of the circular disk 15, substantially prismatic projections 17 protrude on one side in the axial direction. The prismatic projections 17 are preferably distributed around the central orifice 16 of the circular disk 15. Moreover, the top sides 18 of the prismatic projections 17 are preferably flat and disposed in one plane, as illustrated in FIGS. 6 and 8. In one side 9 of the receiving fork 7, openings 19 are provided, through which the prismatic projections 17 of the pressure piece 13 protrude from the outside following the assembly of the driver 4. The threaded sleeve 12 protrudes from the outside into the same side 9 and is held in place corresponding to the central orifice 16 of the circular disk 15 of the pressure piece 13. In the above-described installed position, the pressure piece 13 is retained form the outside of the driver 4 by the threaded nut 11, which is screwed onto the threaded sleeve 12. The threaded sleeve 12 is provided with a bore 20 and preferably a passage, comprising an internal thread at least in some sections. In the other side 10 of the receiving fork 7, a hole 21 is disposed in alignment with the passage of the threaded sleeve for receiving the screw 14. Following the assembly of the driver 4 in accordance with FIGS. 5 and 7, the pressure piece 13 assumes a position in which the prismatic projections 17 protrude slightly on the inside of the first side 9 and hence protrude into the gap 8. In this position, the pressure piece 13 is also secured by the threaded nut 11 against sliding outward. In particular, an end face of the threaded nut 11 comes in contact with the circular disk 15 on the pressure piece 13. The gap 8 remaining between the top sides 18 of the prismatic projections 17 and the inside surface of the opposing side 10 corresponds substantially to the thickness of the window pane that is to be retained. Depending on the application, the threaded nut 11 is preferably knurled or, as illustrated, provided with toothing 22. The toothing 22 may be used later for an assembly tool in order to turn the threaded nut 11.

In this configuration, the driver 4 is equipped for being connected to a window pane. To this end, a perforated, slotted or similarly configured section of the window pane is inserted in the gap 8 of the receiving fork 7 and aligned with its opening with the line of the flush bore 20 in the threaded sleeve 12 and the hole 21 in the opposing side 10. From this side, the screw 14 is inserted through the hole 21 and the opening in the window pane and then screwed into the threaded sleeve 12. After tightening the screw 14, the window pane is non-positively fixed between the top sides 18 of the prismatic projections 17 on the pressure piece 13 and the inside of the opposing side 10. If the opening in the window pane is configured as a hole, a positive connection with defined play is achieved after inserting the screw 14.

The described driver 4 allows the window pane to be newly adjusted following assembly without accessing the screw 14, as is explained in the following. This is particularly useful after installing the window lift mechanism in a vehicle door because in this assembly situation frequent access to the head of the screw 14 is practically impossible or at least very difficult. To loosen the non-positive connection between the window pane and the driver 4, a flat tool is applied to the toothing 22 of the threaded nut 11 and the nut 11 is turned such that it moves slightly away from the pressure piece 13. This way, the pressure force, applied by the prismatic projections 17 of the pressure piece 13 on the window pane, decreases. The window pane can now be newly aligned in its position on the driver 4 to the extent that the play provided between the opening in the window pane and the shank of the screw 14 permits. After aligning the window pane, the threaded nut 11 is retightened against the pressure piece 13. The non-positive connection between the driver 4 and the window pane is thus re-established.

What is claimed is:

1. A driver (4, 5) for a window lift mechanism (1) in a vehicle comprising:
a flat receiving fork (7) and a screw (14) for tightening a gap (8) formed between the sides (9, 10) of the receiving fork (7), wherein one side (9) in the vicinity of the axis of the screw (14) comprises a plurality of openings (19), through which a pressure piece (13) that can be operated from the outside of the side (9) extends into the gap (8) between the sides (9, 10).

2. The driver (4, 5) according to claim 1, wherein the pressure piece (13) can be displaced in a substantially parallel direction to the axis of the screw (14).

3. The driver (4, 5) according to claim 2, wherein the pressure piece (13) is self-locking.

4. The driver (4, 5) according to claim 3, wherein the pressure piece (13) can be operated by means of contact with a threaded nut (11).

5. The driver (4, 5) according to claim 4, wherein the threaded nut (11) is screwed onto a threaded sleeve (12), in the inside bore (2) of which the screw (14) extends.

6. The driver (4, 5) according to claim 5, wherein the threaded nut (11) is knurled.

7. The driver (4, 5) according to claim 6, wherein the threaded nut (11) comprises toothing (22) for applying an assembly tool.

8. The driver (4, 5) according to claim 1, wherein a plurality of openings (19) are disposed in the side (9) about the axis of the screw (14).

9. The driver (4, 5) according to claim 8, wherein the openings (19) are substantially configured as circular ring sectors.

10. The driver (4, 5) according to claim 1, wherein the pressure piece (13) is a round or angular circular disk (15) comprising several prismatic projections (17) that protrude from an end face.
